(19) United States
(12) Patent Application Publication
(10) Pub. No.: US 2025/0276874 A1
(43) Pub. Date: Sep. 4, 2025

(54) Load Block, Crane, Controller for a crane and method to operate a crane

(71) Applicant: Palfinger AG, Bergheim bei Salzburg (AT)

(72) Inventor: Ewald MATHÉ, Elixhausen (AT)

(21) Appl. No.: 18/592,902

(22) Filed: Mar. 1, 2024

(51) Int. Cl. B66C 1/34; B66C 23/16; B66C 23/70

(52) U.S. Cl. CPC B66C 1/34; B66C 23/16; B66C 23/705

(57) ABSTRACT

A load block for a crane comprises a mounting interface to attach a load to the load block. and means to transfer force to a cable. A surface of the load block comprises a functional portion having a shape that causes a turning moment on the load block if the functional portion of the surface engages an abutment.

### FIELD

The present disclosure relates to cranes and to load blocks stored in a transport position while the crane is transported.

### BACKGROUND

If cranes are moved, for example by driving a truck the crane is mounted to, it is often required that a load block is secured by the operator of the crane to prevent it from oscillating during transport. Sometimes it is also required to confirm in a user interface of a crane controller that the load block is brought from a working position to a secure transport position. Securing the load block manually is a time consuming process since the boom system first needs to be moved such that the load block is brought into a configurable working position, allowing the operator to secure the load block. Afterwards, the boom system has to be moved again from the working position to the transport position.

There may be a desire to more efficiently securing the load block of a crane.

### BRIEF DESCRIPTION OF THE FIGURES

Some examples of apparatuses and/or methods will be described in the following by way of example only, and with reference to the accompanying figures, in which

FIG. 1 illustrates an isometric view of an example of a load block;

FIG. 2 illustrates a two dimensional view of a portion of the load block of FIG. 1;

FIG. 3 illustrates an exploded view of the load block of FIG. 1;

FIG. 4 illustrates the transfer of the load block from a working position to a transport position;

FIG. 5 illustrates an example of an abutment for a load block;

FIG. 6 schematically illustrates an example of control circuitry for a crane and a crane;

FIG. 7 illustrates an overview of components used to operate a crane;

FIG. 8 illustrates an example of a user interface; and

FIG. 9 illustrates a flowchart of an example of a method to operate a crane.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

Subsequently, examples of load blocks for cranes and of methods to operate a crane will be discussed.

A crane comprises a boom system mounted to a column of the crane. The column is rotatable with respect to a base of the crane. In some examples, the axis of rotation of the column may be a substantially vertical axis. The angle of rotation about the axis of rotation may be referred to as the slew angle or slewing angle.

The base can be configured to mount the crane onto a platform. The platform may be a fixed platform or a mobile platform. Examples of mobile platforms are vehicles such as trucks, lorries or ships. The boom system can be rotated or moved relative to the column about an axis (e.g. a boom axis) that is essentially perpendicular to the axis of the rotation of the column. The angle of the rotation of the boom system about the boom axis may be referred to as an elevation angle.

Hydraulic cylinders may be used as actuators to create the force to cause the rotation or motation of the boom system with respect to the elevation angle. A boom system comprises at least one (or e.g. one or more booms). In the event of a plurality of booms (e.g. more than one boom), the boom attached to the column may be referred to as the main boom or first boom. Additionally, a second boom attached to the main boom may be referred to as a knuckle boom. Any (or each) of the booms of a boom system can optionally comprise one or more extension booms to be driven in or out of the boom using, for example, hydraulic means. A boom and its extension booms may also be called a boom subsystem.

Cranes having only one boom may also be called stiff boom cranes since they do not exhibit multiple booms that can change their orientation with respect to each other. In the event of cranes having multiple booms, a knuckle can be used to connect the different booms to one another so as to enable them to change their relative orientation, by bending or buckling about an axis defined by the knuckle.

In some examples, a crane may comprise a bendable boom system connected to the crane column. A bendable boom system may comprise a first boom, wherein a first end of the first boom is connected to the crane column. The bendable boom system may further comprise a second boom, wherein the second boom is connected to a second end of the first boom. Cranes having at least two booms connected by a knuckle or hinge offer an additional degree of freedom as compared to stiff boom cranes and may be called knuckle-boom cranes. The booms can be connected by hydraulic cylinders across the knuckle to cause the rotation.

The free end of the boom system not attached to the column may be referred to as the tip of the boom system. Loads may be directly attached to the tip of the boom system. However, cranes may additionally comprise at least one winch mounted to the boom system or elsewhere to the crane, the winch being used to wind und unwind a cable carrying the load. The tip of the boom system may exhibit a wheel for the cable. The cable extends to a load block used to attach the load thereto. In a single wire operation (also called STRAN1) the cable ends in the load block. The cable of the winch may also be used according to the principles of a pulley. If this is the case, the load block exhibits at least one pulley to change the direction of the cable and the cable ends at the boom system, typically close to the tip of the boom system. In the event of a single pulley, operation is also called two wire operation (STRAN2). Of course, multiple pulleys may be used likewise for multi wire operation.

Movement of the crane is caused by using multiple types of actuators such as hydraulic engines, valves and cylinders to cause motion of the booms and electric engines used to cause motion of the column or to operate the winch. Components used to cause movement of the crane or of parts of the crane are called actuators. The movement of the crane is monitored by means of multiple sensors, providing sensors readings indicative of multiple parameters or physical quantities. For example, pressure sensors may be used to monitor the pressure within hydraulic cylinders to determine the forces acting on them. Angle sensors may be used to monitor relative rotation or angle between different parts of the crane (e.g. between the column and the base or between different boom of a knuckle boom crane). Angle sensors may, for example use an encoder wheel together with a sensor sensitive to magnetic fields. Length sensors may be used to monitor the overall length of a boom and its associated extensions. Force sensors may be used to measure force directly or indirectly, for example to measure the force acting on the cable of a winch and/or on the winch itself. Force sensors may, for example, be based on the piezo electric effect or using strain gauges attached to the object being monitored.

The movement of the crane may be controlled by a crane controller that outputs control signals to cause the actuators of the crane to perform an operation. Likewise, the crane controller receives sensor readings to monitor the result of the actuators operation. In some examples, the crane controller may be an integral part of the crane. The desired movement of the crane is typically performed or controlled based on or following a user input. The user input may be manually given by a human operator or supervisor of the crane or it may likewise be generated automatically based on an algorithm or on input parameters generated by other means, such as for example by a trained neural network. For manual input, the crane may exhibit a crane mounted input device (operating panel) having, for example, one or more levers or joysticks to control motion as well as a user interface to input or change user settings and/or crane parameters such as for example different modes of operation of the crane. The input device communicates with the crane controller that transforms the user input into the actuator operations required to result with the desired movement as per the input via the input device. Additionally or alternatively, parts of or all inputs that can be performed using the input device may also be performed using a remote control unit wirelessly communicating with the crane controller.

A crane may be used for multiple purposes by providing the possibility to exchange equipment mounted at the booms of the crane. For example, multiple different attachments can be mounted to the booms close to the tip of the boom system. To support this, the crane may provide a mounting interface close to the tip of the crane. A mounting interface may be composed of multiple elements, mounted to or welded at a boom. Eventually, equipment such as a workmen basket may be mounted to the mounting interface via an adaptor used to adapt the (standard) mounting interface of the crane to a custom mounting interface of the equipment to be used.

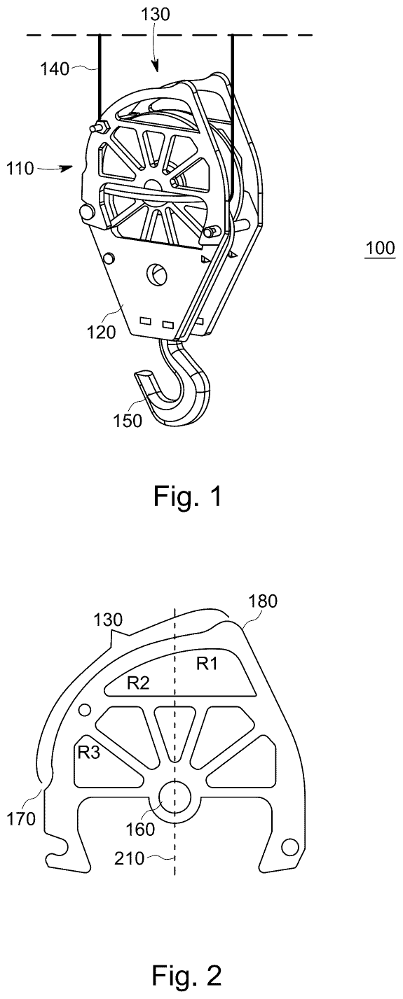

FIG. 1 illustrates an isometric view of an example of a load block 100 for a crane.

The load block 100 comprises a mounting interface 120 to attach a load to the load block. The mounting interface 120 can be an arbitrary element or a structure comprising multiple elements allowing to transfer force from the load block 100 to a load, either directly or by further intermediary elements. In the example illustrated in FIG. 1, the mounting interface comprises a bore 120 that is designed to receive a bolt that holds a hook 150. The hook 150 is an example for an intermediary element to which a load can be attached.

The load block 100 further comprises means to transfer force to a cable 140 of a winch arrangement. The means to transfer force can be an arbitrary element or a structure comprising multiple elements allowing to transfer force from the load block 100 to the cable 140, either directly or by further intermediary elements. In the example of FIG. 1, the means to transfer force to the cable 140 comprises a pulley 110 attached to the load block 100 with a bolt. The cable 140 is routed around the pulley, resulting in STRAN 2 operation of the load block 100 illustrated in FIG. 1.

A surface of the load block comprises a functional portion 130 having a shape that causes a turning moment on the load block 100 if the functional portion 130 of the surface engages with or is pushed towards an abutment. FIG. 2 illustrates a two-dimensional projection of an upper portion of the load block 100.

FIG. 2 also illustrates a central axis 210 of the load block 100, The central axis 210 is defined by the center of the means to transfer load to the cable (the center of bore 160) and by the center of the mounting interface (center of bore 120). The central axis is the axis that may become vertical if a load is attached to the load block 100.

The functional portion 130 has a contour with increasing curvature, the curvature increasing the further the contour deviates from the central axis 210 of the load block element 100. The increasing curvature is schematically illustrated by 3 different radii R1, R2, and R3 in FIG. 2, wherein R1>R2>R3. The increasing curvature results in a turning moment on the load block 100 if the functional portion 130 of the surface engages with or is pushed towards an abutment as illustrated in FIG. 4. The curvature may, for example, be increasing monotonously. According to further examples, the curvature may also be increasing in different finite steps, i.e. segments having identical radii are neighboring each other.

If the curvature increases as illustrated in FIG. 2, the turning moment 410 as illustrated in FIG. 4 is generated if the load block 100 is pulled against an abutment at a tip of the a crane by means of the a winch arrangement winding up cable 140. As a result, the load block 100 illustrated in FIGS. 1 to 3 is brought from a working position 410a to a transport position 410c if the load block 100 is pulled towards the abutment at the tip of the crane. In other words, the functional portion 130 of the load block 100 has a shape that causes a turning moment on the load block 100 if the functional portion 130 of the support block 100 is pushed towards an abutment. The abutment may be plain or tailored in shape to fit the functional portion 130.

As illustrated in FIG. 2, the contour of the functional portion 130 of the surface of the load block 100 may optionally end at a protrusion 170 that may provide a stop for a rotational movement of the load block 100. Similarly, a further protrusion 180 at the opposite end of the functional surface 130 may serve to create an initial moment on the load block 100 once it first engages the abutment at the tip of the crane.

As illustrated, the functional portion 130 of the surface covers at least the surface of the load block 100 opposite the mounting interface, that is, the surface intersects the central axis 210. In other words, the functional portion 130 extends until the central axis 210 at the surface of the support block opposing the mounting interface 120.

If a hook 150 is mounted at load block 100, the curvature may increase in a direction of the open side of the hook 150 in order to enable a safe transport position with the open side of the hook being oriented towards the abutment and the crane.

As illustrated in FIG. 1, the load block 100 can exhibit a pulley for using the load block 100 in a two-wire mode of operation (STRAN2). Further examples may likewise comprise more than a single pulley to support multi-wire operation.

Similarly, further examples of load blocks may be used in a single wire configuration (STRAN1). Those examples may, for example, comprise a bore for a bolt to attach the wire as means to transfer load to the cable. For example, the bolt can be pushed through a soft eye of the cable 140 and to the bore in the load block to transfer the load from the load block to the wire 140.

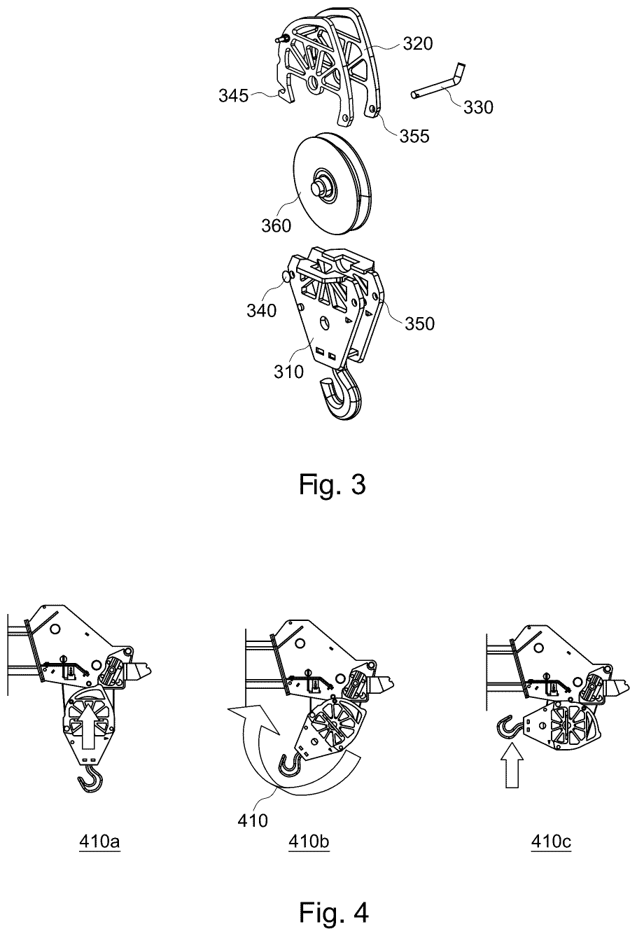

The load block may be composed of multiple elements or it may be monolithic. According to some examples, the load block comprises at least two separable parts as illustrated in the exploded view of a load block 100 in FIG. 3. The two parts may be partly-detachable or fully detachable. Separating the load block 100 in this way may allow to quickly change between single wire operation and dual or multi wire operation.

As illustrated in FIG. 3, a first part 310 of load block 100 comprises the mounting interface and a second part 320 comprises the surface with the functional portion. While the pulley 360 is illustrated as a separate part in FIG. 3, the pulley may also be part of the second part 320 of the load block.

Optionally, the second part 320 may also comprise the means to transfer force to the cable as illustrated in FIG. 3, where the force is transferred via bore 160 in the second part (see, for example, FIG. 2).

Arbitrary mechanical implementations can be used to separably connect the first part 310 and the second part 320 of the load block. For example and as illustrated in FIG. 3, the first part may exhibit a fixed bolt 340 to engage with a recess 345 formed by the second part to connect the parts on one side. Additionally, the first part 310 may comprise a first bore 350 and the second part 320 may comprise a second bore 355 at the opposite side that serve as a bearing for a removable bolt 330 to connect the two parts at the second side and to prevent them from coming loose.

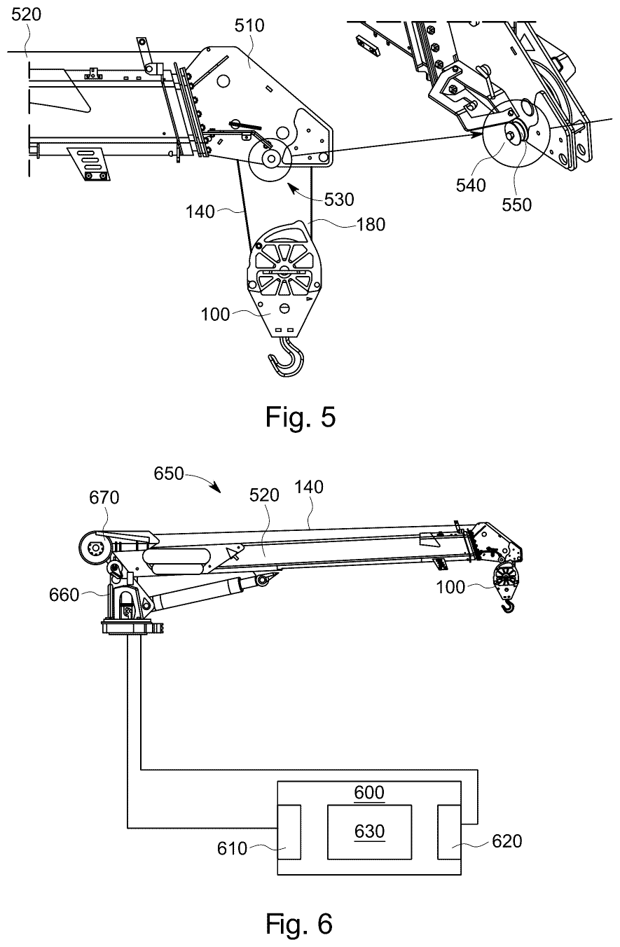

FIG. 5. Illustrates an example of a load block at a tip 510 of a boom system 520 having a single boom of a crane, the tip 510 having an abutment 530 for the functional portion 130 of the surface of the load block 100.

FIG. 5 also illustrates as to how protrusion 180 at the end of the functional portion 130 serves to cause a turning moment of the load block 100 relative to the boom 520 of the crane when the load block 100 initially engages with the abutment.

According to the example illustrated in FIG. 5, the abutment further comprises a bearing 540 rotatable about an axis and positioned such that an outer race 550 of the bearing engages with the functional surface 130 of the load block 100 if the load block 100 engages with the abutment 530.

The outer race 550 serving as a bearing to rotate the load block 100 about may serve to reduce friction and reduce the force required to rotate the load block 100.

In some examples, the axial end faces of the bearing 540 protrude radially further than the outer diameter of the outer race 550. This may increase reliability of system during transfer from the working position to the transport position and during transport since the protrusions prevent the functional surface from disengaging from the outer race 550 in the axial direction. In other words, the protrusions form a guide for the functional surface.

FIG. 6 schematically illustrates an example of control circuitry 600 for a crane and a crane 650.

The crane 650 comprises a boom system 520 mounted on a rotatable column 660 and a winch arrangement 670 attached to the boom system 520 to perform winding or unwinding of cable 140.

The crane 650 further comprises a load block 100 according to any one of the previously described examples. The load block is liftable using the cable 140 and winch arrangement 670.

As illustrated in FIG. 5, an abutment for the load block 500 is formed at a tip of the boom system 520.

Operation of the crane 650 is performed using a crane controller or control circuit 600.

Control circuit 600 comprises an input interface 610 configured to receive readings of sensors sensing operating parameters of the crane 650.

An output interface 620 outputs control data to cause actuators of the crane to perform a motion. A compute circuit 630 is configured to control the operation of the winch arrangement 670 such that the load block 100 attached to a cable 140 of the winch arrangement 670 is transferred from a working position to a transport position as illustrated in FIG. 4.

According to some examples, compute circuit 630 is configured to control the operation of the winch arrangement 670 such that the load block 100 is brought into contact with the abutment 530. The compute circuit 630 is further configured to operate the winch arrangement 670 such that the load block 100 is rotated until the load block 100 reaches transport position 410c illustrated in FIG. 4.

According to some examples, the compute circuit 630 is configured to control the operation of the winch arrangement 670 such that the load block 110 is rotated between 70° and 110°.

According to some examples, compute circuit 630 is configured to control the operation of the winch arrangement 670 such that the winch arrangement 670 automatically winds up the cable 140 until a sensor reading of a force sensor indicating a force acting on the cable 140 indicates a reference force.

To this end, the input interface 610 may be configured to receive a sensor reading of a force sensor indicating a force acting on the cable 140. The compute circuit 630 is configured to control the operation of the winch arrangement 670 based on at least one of the force acting on the cable 140 or the length of the boom 520s.

According to some examples, the winch arrangement 140 is controlled to wind up the cable 140 until a single reference force is reached. According to further examples, the winch arrangement 140 is controlled to wind up the cable 140 until a first reference force is reached when the load hook 100 engages the abutment 530. Afterwards, the winch arrangement 140 is controlled to further wind up the cable 140 until a second reference force is reached. The second reference force corresponds to position 410c when further increasing the force doesn't result in a further rotation of the load block 100. Optionally, the speed at which the winch arrangement 140 winds up the cable 140 after reaching the first reference force is smaller than before.

According to some examples, the compute circuit 630 is optionally furthermore configured to control the operation of the boom system 520 such that extensions of booms of the boom system are entirely pulled back automatically before the winch arrangement 670 is made to bring the load block 100 in the transport position.

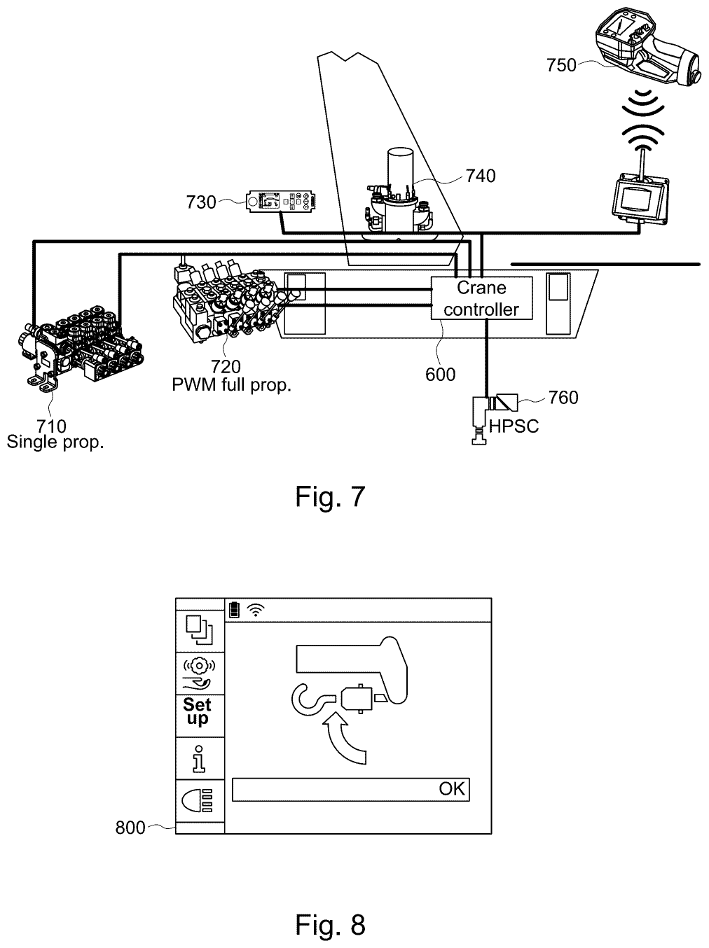

FIG. 7 schematically illustrates an overview of some components involved and interacting to operate a crane as illustrated in FIG. 6.

Control circuitry 600 (also referred to as a crane controller) comprises one or more input interfaces configured to receive readings of sensors that sense operating parameters of the crane. While the previous paragraphs give some examples of sensed parameters, it is to be noted that these examples are not exhaustive and that multiple further parameters or sensor readings may be processed by control circuitry 600.

Control circuitry 600 further comprises one or more output interfaces to output control data to cause actuators of the crane to perform a movement. Transmission and reception of the sensor readings and of the input signals and of the control data may be performed using arbitrary wired or wireless systems and data protocols. Examples of wired protocols may be ControllerAreaNetwork (CAN), FlexRay, Local Interconnect Network (LIN), MOST or Ethernet. The control circuit 100 may submit digital commands as control data that need to be interpreted by the actuators before these autonomously control their movement or action or the control data may be such that the actuators are directly controlled by the control circuit 110. For example, Pulse Width Modulated signals (PWM) may be used to directly steer actuators.

Amongst the actuators controlled may be hydraulic engines 710 and 720 to control the movement of the booms of the boom system and of legs or outriggers 760 extending from the base of the crane to increase its stability. Likewise, an engine 740 used to rotate the column of the crane may be controlled by control circuitry 600.

A control panel 730 mounted at the crane and an optional remote control unit 750 communicate with the control circuitry 600. Both comprise a user interface to provide a user input for tasks and movements to be performed by the crane. For the examples described herein, at least one of the control panel 730 and the remote control unit 750 are configured to receive user input and to cause the control circuitry 600 to transfer the load block attached to the cable of the winch arrangement from a working position to a transport position.

FIG. 8 illustrates an example of a graphical user interface that may be used at one or both of the control panel 730 and the remote control unit 750 to enable a user to start an example of a method to automatically transfer a load block of a crane from a working position to a transport position.

Automatically transferring the load block to the transport position means that none of the actuators of a crane is steered by means of a user input to the control panel 730 or the remote control unit 750 during the transfer.

According to some examples, the method is performed fully automatically requiring no further operator interaction or supervision after starting it by, for example, hitting the OK button in the user interface 800.

According to some examples, the method is performed automatically but under supervision of an operator. The operator may, therefore, be required to keep an input element activated or pressed while the actuators of the crane perform the movements required to transfer the load block from the working position to the transport position. This operating principle is also called a dead-man switch. Whenever the operator releases the input element, the actuators are caused to stop. Input elements used to implement this functionality at the control panel 730 or the remote control unit 750 are arbitrary. For example, a switch used to select one of the multiple actuators may be used or a lever used otherwise to adjust the speed of a selected actuator may be used for the same purpose.

Both examples may additionally provide the possibility to temporarily or permanently overrule the automatic control of the actuators of the crane by activating a dedicated input element at control panel 730 or at remote control unit 750. Similarly to the dead-man switch functionality, arbitrary input elements present at the control panel 730 or the remote control unit 750 may be used for said purpose.

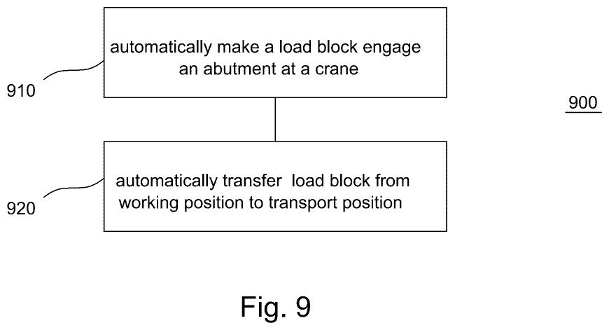

FIG. 9 illustrates a flowchart of an example of a method 900 to operate a crane.

The method comprises controlling 910 the operation of a winch arrangement mounted at a boom system of the crane such that a load block attached to a cable of the winch arrangement automatically engages with an abutment.

The method further comprises controlling 900 the operation of the winch arrangement such that the load block is automatically transferred from a working position to a transport position.

In the following, some examples of the proposed concept are presented:

An example (e.g., example 1) relates to a load block for a crane, the load block comprising, a mounting interface to attach a load to the load block, means to transfer force to a cable, wherein a surface of the load block comprises a functional portion having a shape that causes a turning moment on the load block if the functional portion of the surface engages an abutment.

Another example (e.g., example 2) relates to a previous example (e.g., example 1) or to any other example, further comprising that the functional portion has a contour with increasing curvature, the curvature increasing the further the contour deviates from a central axis of the support element, the central axis being defined by the center of the means to transfer load to the cable and by the center of the mounting interface.

Another example (e.g., example 3) relates to a previous example (e.g., example 2) or to any other example, further comprising that the functional portion of the surface extends until the central axis at the surface of the support block opposing the mounting interface.

Another example (e.g., example 4) relates to a previous example (e.g., one of the examples 1 to 3) or to any other example, further comprising that the mounting interface comprises a bore configured to serve as a bearing for a bolt supporting a hook.

Another example (e.g., example 5) relates to a previous example (e.g., one of the examples 1 to 4) or to any other example, further comprising a hook attached to the mounting interface.

Another example (e.g., example 6) relates to a previous example (e.g., one of the examples 4 or 5) or to any other example, further comprising that the curvature increases in a direction of the open side of the hook.

Another example (e.g., example 7) relates to a previous example (e.g., one of the examples 1 to 6) or to any other example, further comprising that the load block exhibits one or more pulleys for using the load block in a two-wire mode of operation or in a multi-wire mode of operation.

Another example (e.g., example 8) relates to a previous example (e.g., one of the examples 1 to 7) or to any other example, further comprising a bore for a bolt to attach the wire.

Another example (e.g., example 9) relates to the load block comprising a first part and a separable second part, the first part comprising the mounting interface, and the second part comprising the surface with the functional portion and the means to transfer force to the cable.

Another example (e.g., example 10) relates to wherein the first part comprises a fixed bolt to engage with a recess formed by the second part and a first bore serving as a bearing for a removable bolt, and wherein the second part comprises the recess to engage with the re-movable bolt of the first part and a second bore serving as a bearing for the removable bolt.

Another example (e.g., example 11) relates to a previous example (e.g., one of the examples 1 to 10) or to any other example, further comprising that the functional portion has a shape that causes a turning moment on the load block if the functional portion of the support block is pushed towards a planar abutment.

Another example (e.g., example 12) relates to a previous example (e.g., one of the examples 1 to 11) or to any other example, further comprising that the functional portion comprises a protrusion for interacting with an abutment of a boom of the crane, wherein the protrusion causes a turn-ing moment of the load block with respect to the boom of the crane.

An example (e.g., example 13) relates to a crane comprising a boom system mounted on a rotatable column, a winch arrangement attached to the crane to perform winding or unwinding of a cable of the winch arrangement, and a load block according to any one of examples 1 to 12 attached to the cable.

Another example (e.g., example 14) relates to a previous example (e.g., example 13) or to any other example, further comprising an abutment for the load block at a tip of the boom system.

Another example (e.g., example 15) relates to a previous example (e.g., example 14) or to any other example,, wherein the abutment comprises a bearing rotatable about an axis and positioned such that an outer race of the bearing engages with the functional surface of the load block if the load block engages with the abutment.

Another example (e.g., example 16) relates to a previous example (e.g., example 15) or to any other example, further comprising that both end faces of the bearing in a direction defined by the axis protrude further than an outer diameter of the outer race of the bearing to prevent the functional surface from dis-engaging the outer race in the axial direction.

Another example (e.g., example 17) relates to a previous example (e.g., one of the examples 13 to 16) or to any other example, further comprising that the boom system comprises a main boom connected to the rotatable column, the main boom comprising at least one extension, wherein the abutment for the load block is present at the tip region of the main boom.

An example (e.g., example 18) relates to control circuitry for a crane, comprising an input interface configured to receive readings of sensors sensing operating parameters of the crane, an output interface to output control data to cause actuators of the crane to perform a motion, and a compute circuit configured to control the operation of a winch arrangement mounted at a boom system of the crane such that a load block attached to a cable of the winch arrangement is transferred from a working position to a transport position.

Another example (e.g., example 19) relates to a previous example (e.g., example 17) or to any other example, further comprising that the compute circuit is configured to control the operation of the winch arrangement such that the load block is brought into contact with an abutment at the boom system, and the load block is rotated until the load block reaches a transport position.

Another example (e.g., example 20) relates to a previous example (e.g., one of the examples 17 or 18) or to any other example, further comprising that the compute circuit is configured to control the operation of the winch arrangement such that the load block is rotated between 70° to 110°.

Another example (e.g., example 21) relates to a previous example (e.g., one of the examples 17 to 19) or to any other example, further comprising that the compute circuit is configured to control the operation of the winch arrangement such that the winch arrangement automatically winds up the cable until a sensor reading of a force sensor indicating a force acting on the cable indicates a reference force.

Another example (e.g., example 22) relates to a previous example (e.g., one of the examples 17 to 20) or to any other example, further comprising that the compute circuit is configured to control the operation of the boom system such that extensions of booms of the boom system are entirely pulled back automatically.

Another example (e.g., example 23) relates to a previous example (e.g., one of the examples 17 to 21) or to any other example, further comprising that the input interface is configured to receive a sensor reading of a force sensor indicating a force acting on the cable and a sensor reading of a boom extension sensor indicating a length of a boom, wherein the compute circuit is configured to control the operation of the winch arrangement based on at least one of the force acting on the cable or the length of the boom.

Another example (e.g., example 24) is a remote control unit to wirelessly interact with control circuitry according to any one of examples 17 to 22 to cause the control circuitry to transfer the load block attached to the cable of the winch arrangement from a working position to a transport position.

Another example (e.g., example 25) relates to a previous example (e.g., example 23) or to any other example, further comprising that the remote control unit comprises a user interface configured to enable an auto store function causing the control circuitry to transfer the load block attached to the cable of the winch arrangement from a working position to a transport position.

Another example (e.g., example 26) relates to a previous example (e.g., one of the examples 23 or 24) or to any other example, further comprising that the remote control unit further comprises a control switch, wherein the auto store function is interrupted when the control switch is released.

An example (e.g., example 27) relates to method to control a crane, comprising control the operation of a winch arrangement mounted at a boom system of the crane such that a load block attached to a cable of the winch arrangement automatically engages with an abutment, and control the operation of the winch arrangement such that the load block is automatically transferred from a working position to a transport position.

Another example (e.g., example 28) relates to a previous example (e.g., example 26) or to any other example, further comprising automatically winding up the cable until a sensor reading of a force sensor indicates that a force acting on the cable reaches a reference force.

Another example (e.g., example 29) relates to The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A load block for a crane, the load block comprising;
a mounting interface to attach a load to the load block,
means to transfer force to a cable, wherein a surface of the load block comprises a functional portion having a shape that causes a turning moment on the load block if the functional portion of the surface engages an abutment.

2. The load block of claim 1, wherein the functional portion has a contour with increasing curvature, the curvature increasing the further the contour deviates from a central axis of the support element, the central axis being defined by the center of the means to transfer load to the cable and by the center of the mounting interface.

3. The load block of claim 2, wherein the functional portion of the surface extends until the central axis at the surface of the support block opposing the mounting interface.

4. The load block of claim 1, wherein the mounting interface comprises a bore configured to serve as a bearing for a bolt supporting a hook.

5. The load block of claim 1, further comprising a hook attached to the mounting interface.

6. The load block of claim 4, wherein the curvature increases in a direction of the open side of the hook.

7. The load block of claim 1, wherein the load block exhibits one or more pulleys for using the load block in a two-wire mode of operation or in a multi-wire mode of operation.

8. The load block of claim 1, further comprising a bore for a bolt to attach the wire.

9. The load block of claim 1, the load block comprising a first part and a separable second part,
the first part comprising the mounting interface; and
the second part comprising the surface with the functional portion and the means to transfer force to the cable.

10. The load block of claim 9,
wherein the first part comprises a fixed bolt to engage with a recess formed by the second part and a first bore serving as a bearing for a removable bolt; and
wherein the second part comprises the recess to engage with the removable bolt of the first part and a second bore serving as a bearing for the removable bolt.

11. The load block of claim 1, wherein the functional portion has a shape that causes a turning moment on the load block if the functional portion of the support block is pushed towards a planar abutment.

12. The load block of claim 1, wherein the functional portion comprises a protrusion for interacting with an abutment of a boom of the crane, wherein the protrusion causes a turning moment of the load block with respect to the boom of the crane.

13. A crane comprising:
a boom system mounted on a rotatable column;
a winch arrangement attached to the crane to perform winding or unwinding of a cable of the winch arrangement; and
a load block according to claim 1 attached to the cable.

14. The crane of claim 13, further comprising:
an abutment for the load block at a tip of the boom system.

15. The crane of claim 14, wherein the abutment comprises a bearing rotatable about an axis and positioned such that an outer race of the bearing engages with the functional surface of the load block if the load block engages with the abutment.

16. The crane of claim 15, wherein both end faces of the bearing in a direction defined by the axis protrude further than an outer diameter of the outer race of the bearing to prevent the functional surface from disengaging the outer race in the axial direction.

17. The crane of claim 13, wherein the boom system comprises a main boom connected to the rotatable column, the main boom comprising at least one extension, wherein the abutment for the load block is present at the tip region of the main boom.
